(19) United States
(12) Patent Application Publication
(10) Pub. No.: US 2014/0253780 A1
(43) Pub. Date: Sep. 11, 2014

(54) METHOD OF ADJUSTING LIGHT DETECTION ALGORITHM

(71) Applicant: Capella Microsystems (Taiwan), Inc., New Taipei City (TW)

(72) Inventor: Cheng-Chung SHIH, Fremont, CA (US)

(73) Assignee: Capella Microsystems (Taiwan), Inc., New Taipei City (TW)

(21) Appl. No.: 13/970,892

(22) Filed: Aug. 20, 2013

Related U.S. Application Data
(60) Provisional application No. 61/772,883, filed on Mar. 5, 2013.

(51) Int. Cl. G01J 1/42

(52) U.S. Cl. CPC G01J 1/4204
USPC 348/335; 250/214 AL

(57) ABSTRACT

A method of adjusting light detection algorithm is disclosed. The method of adjusting light detection algorithm comprises steps of obtaining a position information of a mobile device comprising at least one light sensor; determining an ambient light information by the at least one light sensor; and adjusting a light detection algorithm according to the position information and the ambient light information.

### CROSS-REFERENCE TO RELATED APPLICATION

This application claims the benefit of U.S. Provisional Application No. 61/772,883, filed on Mar. 5, 2013, the disclosure of which is incorporated herein in its entirety by reference.

### BACKGROUND OF THE INVENTION

1. Field of the Invention

The present invention generally relates to a method of adjusting algorithm, in particular to a method of adjusting light detection algorithm in mobile devices according to position information and ambient light information.

2. Description of the Related Art

In most of the mobile devices available in the market, the mobile devices generally comprise cameras, light sensors and position sensors. Wherein, the light sensor may comprise an ambient light sensor and a RGB sensor for detecting illuminance or chromaticity of an ambient light. In addition, the position sensors may comprise accelerometer and gyroscope for measuring proper acceleration and orientation of the mobile devices.

Nowadays, people like to take pictures by their mobile devices for its portable feature and convenience. However, the present mobile devices apply one algorithm to calculate the light detected by the light sensors for each scenario and transfer the calculated data to the camera for processing the picture taken. However, the pictures with the brightness or color similar to the object, i.e. the accurate brightness or color, may not be obtained by the cameras without proper light detection and picture processing. Thus, how to achieve the proper light detection and picture processing so as to provide the pictures with the accurate brightness or color to the user has become an issue.

The information disclosed in the Background of the Invention section is provided only for better understanding of the background of the invention, and should not be taken as an acknowledgment or any form of suggestion that this information forms a prior art that would already be known to a person skilled in the art.

### SUMMARY OF THE INVENTION

Therefore, it is a primary objective of the present invention to provide a method of adjusting light detection algorithm to achieve the effect of adjusting the best light detection algorithm according to various positions of a mobile device and ambient light conditions, thereby improving the detection accuracy of ambient light.

To achieve the foregoing objective, the present invention provides a method of adjusting light detection algorithm, comprising: obtaining a position information of a mobile device comprising at least one light sensor; determining an ambient light information by the at least one light sensor; and adjusting a light detection algorithm according to the position information and the ambient light information.

In a preferred embodiment of the present invention, the position information may comprise inclination or front/rear direction of the mobile device. Wherein, the position information may be obtained by at least one position sensor of the mobile device. Preferably, the at least one position sensor may comprise an accelerometer, a gyrometer, a GPS or a pressure sensor.

In a preferred embodiment of the present invention, the mobile device may further comprise at least one camera, and the position information may further comprise a relative position of the at least one light sensor and the currently used at least one cameras.

In a preferred embodiment of the present invention, the method of adjusting light detection algorithm may further comprise adjusting a photographing parameter of the mobile device according to the light detection algorithm. Wherein, the photographing parameter comprises exposure time, F-number, flash light or ISO value.

In a preferred embodiment of the present invention, the light sensor may comprise a RGB sensor, ultra violet sensor, infra red sensor, white light sensor or an ambient light sensor. Preferably, the ambient light information comprising color temperature, illuminance or chromaticity.

In a preferred embodiment of the present invention, the method of adjusting light detection algorithm may further comprise adjusting a display parameter of the mobile device according to the light detection algorithm. Wherein, the display parameter may comprise white balance, illuminance or chromaticity.

The method of adjusting light detection algorithm according to the present invention adjust light detection algorithm according to the various positions of a mobile device and ambient light conditions, so that the present invention has the following advantages:

(1) The method of adjusting light detection algorithm according to the present invention allows the cameras of a mobile device to adjust to the optimal light detection algorithm for various positions of the mobile device so as to achieve more accurate light detection.

(2) The method of adjusting light detection algorithm according to the present invention allows the user to capture images with colors that are much more similar to the object.

(3) The method of adjusting light detection algorithm according to the present invention allows the display of the mobile device to display images with colors that are much more similar to the object.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a flow chart of a method of adjusting light detection algorithm according to an exemplary embodiment of the present invention;

FIG. 2 is a schematic view of a method of adjusting light detection algorithm in accordance with an embodiment of the present invention; and

FIG. 3 is a schematic view of a method of adjusting light detection algorithm in accordance with another embodiment of the present invention.

### DETAILED DESCRIPTION OF THE PREFERRED EMBODIMENTS

The present invention will be described more fully hereinafter with reference to the accompanying drawings, in which exemplary embodiments of the invention are shown.

As those skilled in the an would realize, the described embodiments may be modified in various different ways, all without departing from the spirit or scope of the present invention.

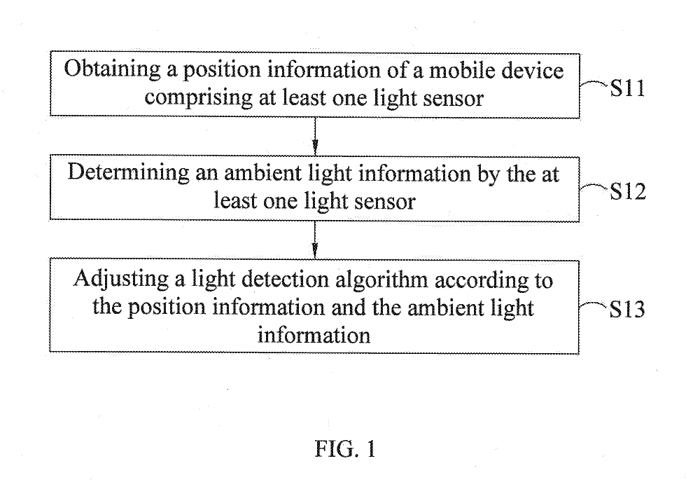

FIG. 1 is a flow chart of a method of adjusting light detection algorithm according to an exemplary embodiment of the present invention.

Referring to FIG. 1, the method of adjusting light detection algorithm comprises steps of S11: obtaining a position information of a mobile device comprising at least one light sensor; S12: determining an ambient light information by the at least one light sensor; and S13: adjusting a light detection algorithm according to the position information and the ambient light information.

In an embodiment, the mobile device may comprise a mobile phone or tablet that is portable and comprises at least one light sensor for light detection. Preferably, the mobile device may further comprise at least one cameras for photo shooting. Wherein, the at least one camera may be installed in the opposite sides of the mobile device, for instance, front and rear sides of the mobile device. In an embodiment, the at least one light sensor may be installed on the same side as the camera. In another embodiment, the at least one light sensor may be installed at the different sides as the camera.

In a preferable embodiment, the mobile device may comprise at least one position sensor, such as an accelerometer, a gyrometer, a GPS or a pressure sensor, for obtaining the position information of a mobile device, for example, inclination or front/rear direction of the mobile device, or a relative position of the at least one light sensor and the currently used at least one cameras.

The light sensor may comprise RGB sensor, ultra violet sensor, infra red sensor, white light sensor or an ambient light sensor so as to gather ambient light information, such as color temperature, illuminance or chromaticity. The position information of the mobile device and the ambient light information may be applied to help adjusting the light detection algorithms to the most accurate one under the circumstance so as to calibrate the ambient light information, thereby obtaining the images with the most accurate brightness or color.

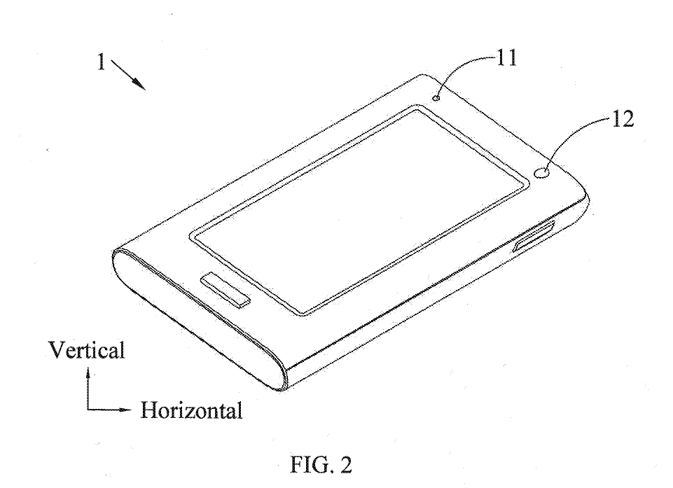

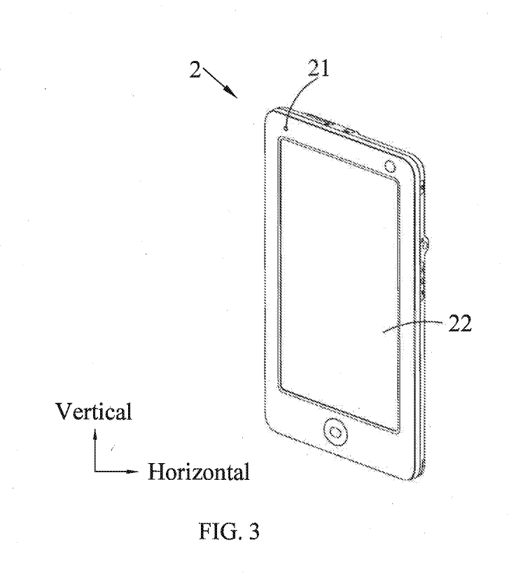

FIG. 2 is a schematic view of a method of adjusting light detection algorithm in accordance with an embodiment of the present invention, and FIG. 3 is a schematic view of a method of adjusting light detection algorithm in accordance with another embodiment of the present invention.

Referring to FIG. 2, a mobile device 1 is positioned flat with its front side facing upward. A RGB sensor 11 and a front camera 12 are installed at the front side of the mobile device I, and the RGB sensor 11 is viewing the same direction as the front camera 12. In the embodiment, the light illuminates from above. Thus, when a user is taking a picture using the front camera 12, the position information of the mobile device 1 is obtained to be flat with front side upward and the relative position between the RGB sensor 11 and the front camera 12 is determined to be on the same side. In addition, the RGB sensor 11 determines the ambient light information comprising color temperature and chromaticity. Afterwards, a light detection algorithm will be adjusted according to the position information of the mobile device 1 including he relative position between the RGB sensor 11 and the front camera 12 and the ambient light information so as to calibrate photographing parameters, such as exposure time, F-number, flash light or ISO value, with the most suitable light detection algorithm under the circumstance, thereby obtaining the images with the most accurate brightness or color comparing to the object. In the instant case, the ambient light information from the RGB sensor 11 may be treated as the object brightness and color temperature.

Referring to FIG. 3, a mobile device 2 is positioned upright with its front side facing a user. An ambient light sensor 21 and a display 22 are both installed at the front side of the mobile device 2. Namely, and the ambient light sensor 21 is viewing the different directions as the display 22. In the embodiment, the light illuminates from above. Thus, when a user is viewing an image with the display 22, the position information of the mobile device 2 is obtained to be upright and the relative position between the ambient light sensor 21 and the display 22 is determined to be at the same side. Furthermore, the ambient light sensor 21 determines the ambient light information comprising illuminance. Afterwards, a light detection algorithm will be adjusted according to the position information of the mobile device 2 including the relative position between the ambient light sensor 21 and the display 22 and the ambient light information, so as to calibrate display parameters, such as white balance, illuminance or chromaticity, with the most suitable light detection algorithm, thereby obtaining the displayed images with the most accurate brightness or color in the display 22. In the instant case, the ambient light information from the ambient light sensor 21 may be treated as the environmental brightness and color temperature.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A method of adjusting light detection algorithm, comprising:
obtaining a position information of a mobile device comprising at east one light sensor;
determining an ambient light information by the at least one light sensor; and
adjusting a light detection algorithm according to the position information and the ambient light information.

2. The method of claim 1, wherein the position information comprising inclination or front/rear direction of the mobile device.

3. The method of claim 2, wherein the position information is obtained by at least one position sensor of the mobile device.

4. The method of claim 3, wherein the at least one position sensor comprising an accelerometer, a gyroscope, a UPS or a pressure sensor.

5. The method of claim 2, wherein the mobile device further comprises at least one camera.

6. The method of claim 5, wherein the position information further comprises a relative position of the at least one light sensor and the currently used at least one cameras.

7. The method of claim 6, further comprising adjusting a photographing parameter of the mobile device according to the light detection algorithm.

8. The method of claim 7, wherein the photographing parameter comprises exposure time, F-number, flash light or ISO value.

9. The method of claim 1, wherein the light sensor comprising a RUB color sensor, ultra violet sensor, infra red sensor, white light sensor or an ambient light sensor.

10. The method of claim 9, wherein the ambient light information comprising color temperature, illuminance or chromaticity.

11. The method of claim 1, further comprising adjusting a display parameter of the mobile device according to the light detection algorithm.

12. The method of claim 11, wherein the display parameter comprises white balance, illuminance or chromaticity.
